(19) United States
(12) Patent Application Publication
(10) Pub. No.: US 2008/0060751 A1
(43) Pub. Date: Mar. 13, 2008

(54) Island label apparatus and method

(76) Inventor: Evan Arrindell, Germantown, TN (US)

Correspondence Address: BAKER, DONELSON, BEARMAN, CALDWELL & BERKOWITZ, SIX CONCOURSE PARKWAY, SUITE 3100, ATLANTA, GA, 30328, US

(21) Appl. No.: 11/517,153

(22) Filed: Sep. 7, 2006

(51) Int. Cl. B32B 37/00

(52) U.S. Cl. 156/248; 156/511

(57) ABSTRACT

A multi-web single-pass converting system apparatus and method by which predetermined zones of an adhesive surface are formed on a label material web from which discrete labels are cut and transferred to a receiving flow wrap web in overlapping relation to openings cut in the flow wrap web to form a labeled flow wrap assembly for the production of labeled flexible packaging for wipe sheet products and perishable products with the label providing a resealable closure for the opening into the package.

### TECHNICAL FIELD

The present invention relates to apparatus and methods for producing labeled flow wrap assembly for product packaging. More particularly, the present invention relates to an apparatus and method for assembling labeled flow wrap with a linerless label placed as an island on converted film flow wrap for use with resealable labeled packaging for goods.

### BACKGROUND OF THE INVENTION

Convenience products, including wipe sheets and edibles such cookies, chips, and other snack foods, are typically packaged in readily openable, re-sealable containers. Wipe sheets, and particularly wet wipe sheets that once were synonymous with “baby wipes” because of their predominant use for baby care, have proliferated as the medium of choice for a wide variety of other personal and household uses including makeup removal, personal cleansing, pet care, household surface cleaning, grill preparation, automotive cleaning, to name but a few of the applications using dampened fabric sheets for carrying a wet fluid and applying the fluid to a surface.

In concert with the diverse and widespread use of wet wipe sheets, and to meet consumer demand for convenience features, flexible packaging for wipe sheets has grown to rival rigid containers such as tubs and canisters. Flexible packaging, or pouches, offers a variety of count sizes from smaller counts of less than 12 for travel and convenience purposes to larger refill packages of 60 to 80 or more. Flexible pouches are readily produced with flow wrap technology and are constructed from a variety of films and film combinations including polypropylene, polyethylene, and other materials. As an added convenience, many flexible pouches now include a resealable opening. The opening is formed by a diecut or perforated area on the flow wrap material. A resealable label applied to the flow wrap material overlaps the opening and surrounding surface. The consumer peals the label away from the surface to access the contents of the package through the opening. The feature of “resealablity” is made possible by the label that covers the diecut opening. The adhesive formulation applied to a contact surface of the label allows for repeatable openings of the package. Further, the re-sealing of the opening with the label helps preserve the moisture content in the wipe sheets and thus prevent drying of the sheets prior to use.

Heretofore, the labeled flow wrap assembly is manufactured on a production line to make a roll of an extended length of labeled flow wrap sheets. The roll is subsequently used on a packaging line that seals overlapped edges to form the resealable pouch for enclosing products made by the manufacturer and then cuts the labeled flow wrap sheets to length. In the process, pressure sensitive labels are diecut on a carrier or liner and made available in rolls on a core. The rolls of the diecut labels are then webbed through a label applicator that is placed in proximity of a web of the flow wrap film. The flow wrap web is diecut in register to create the eventual opening for the pouch, with the diecut piece retained in the web with small ties or connecting pieces. After the opening in the film web is diecut, the label is applied overlapping the diecut area of the flow wrap web. As an alternative, the web may be labeled first and then diecut from the underside of the web using the label as the backing. The flow wrap/label assembly is then wound into a roll. Typically, the label making process and the flow wrap converting process takes place on two separate lines and is non-continuous. That is, finished labels must be produced before the diecutting of the flow wrap web and the application of the labels to the flow wrap web. Consequently, the conventional manufacturing processes use linered label stock, and formation of the label/film assembly occurs in two distinct processes.

While such processes and materials have provided labeled flow wrap webs for pouch production, there are drawbacks to such. Materials expense pressures arising from high volume flow wrap users have created a demand for a lower cost label. Nevertheless, label cost reductions have been incremental, and have been achieved through the use of clear unprinted labels and smaller labels.

In addition, product manufacturers and marketers operate in an increasingly competitive marketplace. Consumers seek the functionality and convenience of resealability on convenience packages such as wipe sheets packages, and in particular with flexible pouches. To grow or preserve market share and control expenses, large volume product manufacturers seek to reduce packaging costs yet continue to provide packages that offer consumers more functionality, better and more appealing graphics, and other features that add value perceived by the consumer as an inducement to purchase.

While global sourcing of film flow wrap has helped to reduce total packaging costs, savings on the label material have been modest in comparison. There is also growing concern about the environmental impact caused by the disposal of label liner waste discarded after the label manufacturing process. Such liners are generally siliconized and carry adhesive residue that render them largely non-recyclable. The reduction in the use of liners therefore offers perceived environmental and societal benefits.

In that regard, AWA Alexander Watson Assoc. recently authored a study on the North American market entitled “Labeling Markets: North American Sourcebook 2004”, published by the Paper Film and Foil Converters (PFFC) and www.pffc-oline.com, a noted trade publication for the label and packaging converting industry. It is reported that in 2003, release liners used for selfadhesive materials accounted for 92% of the total worldwide market (25,500 million square meters).

Usage in North America approximated 4,700 million square meters, or 1,814 square miles. Roughly 96% of such liners were paper-based. Calendared Kraft liners dominate the North American market with an approximate 79% share. Put in perspective, in the year 2003, siliconized liner usage in the North American adhesive label market was such as would cover almost the entire land area of the State of Delaware, and exceeds the land area of the State of Rhode Island.

The following Chart illustrates the environmental impact of calendared Kraft liners only (using a 0.1% recycled content), according to the Environmental Defense Paper Calculator. Using known liner weights of 0.11 pounds per square foot, and a calendared Kraft (North American share) of 3,713 million square meters or equivalently 39,949 million square feet, yields 270,948 tons of supercalandared paper. More information is available at http://www.papercalculator.org.

CHART
Environmental Impact of Calendared Kraft Liners
(North America Usage - 2003)

| | |
|---|---|
| Wood Use: | 601,354 tons of wood |
| Total Energy | 8,902,610 million BTU |
| Purchased Energy: | 6,658,391 million BTU |
| Sulfur Dioxide | 8,385,977 pounds |
| Greenhouse Gases | 1,856,410,748 lbs CO2 |
| | equivalent |
| Nitrogen Oxides | 5,273,906 pounds |
| Particulates | 3,018,211 pounds |
| Hazardous Air Pollutants | 259,822 pounds |
| Volatile Organic Compounds | 1,070,136 pounds |
| Total Reduced Sulfur | 29,460 pounds |
| Wastewater | 4,061,231,674 gallons |
| Biochemical Oxygen Demand | 981,649 pounds |
| Total Suspended Solids | 1,710,187 pounds |
| Chemical Oxygen Demand | 14,196,313 |
| Absorbable Organic Halogens | 80,861 pounds |
| Solid Waste | 634,774,785 pounds |

Liner and matrix waste together with packaging waste has become a major waste management issue in the European community, and recycling of liners and matrix waste has met with limited success. It is expected that similar concerns will arise in North America. For example, in a PFFC online article entitled Waste Not: Waste Management in Europe's Packaging and Label Industries, Corey Reardon, (a principal of international market research and consulting firm AWA Alexander Watson Assoc., a company that specializes in supporting the coating, laminating, and converting industries with private market studies and industry-specific supply-chain conferences) notes that “In 1994 the European Union (EU) issued its first ever Packaging and Packaging Waste Directive, aimed mainly at reducing the amount of landfill and incineration without energy recovery (two major global environmental concerns), and secondly at driving down the levels of waste in the packaging industry as a whole. To achieve this, the EU encourages the following steps: minimization of the amount of material used in packaging applications; re-use of components; recovery; and recycling.” See http://pffc-online.com/mag/paper_waste_not/.

Previous efforts to form linerless label material have had at best marginal success. These materials often require additional coatings on the face of the label to achieve a non-stick surface so the material, wound upon itself, is releasable in the manufacture of the labeled flow wrap web assembly. The cost of these coating materials and the need to find compatible coatings for the various adhesives used for the labels have also tended to negate the savings arising from elimination of the liner.

Additionally, labeling technologies for linerless webs of label material remain slow and unsuitable for high speed labeling of flexible web materials.

Consequently, the conventional process for producing assembled labeled flow wrap webs is for label manufacturers to buy linered label stock, or manufacture the label stock themselves. The linered stock is thereafter printed and die cut to form the labels in accordance with the needs of the customers. This requires label manufacturers to maintain large inventories of stock of a wide variety of types and sizes so as to be able to fill, on relatively short notice, customers' orders. Not only are such inventories expensive to maintain and store, but the label stock itself is expensive to purchase.

Hence, there exists a long standing need to devise a process for converting linerless label material, and a process for labeling items with linerless labels at a minimum cost.

Accordingly, there is a need in the art for an improved apparatus and method for the manufacture of labeled flow wrap web assemblies for use in packaging of convenience products. It is to such that the present invention is directed.

### SUMMARY OF THE INVENTION

The present invention meets the needs in the art by providing a multi-web converting system for the production of labeled flexible packaging for making labeled flow wrap packaging for wipes and perishable products, comprising two separate webs consisting of a) a label material web and b) a receiving flow wrap web for converting on a one-pass apparatus to form a labeled flow wrap assembly, defining predetermined zones of adhesive coating on the label material web, diecutting the label material web in register into discrete pressure sensitive labels in sequence, diecutting a dispensing opening in the receiving flow wrap web for a package in sequence, passing the diecut label material web and the diecut flow wrap web through an island placement module where the discrete diecut labels are applied in register to the flow wrap web with each label in adhesive contact overlapping one of the diecut opening of the flow wrap in sequence to form the labeled flow wrap assembly, and accumulating the labeled flow wrap assemblies for use in making labeled flexible packaging.

In another aspect, the present invention provides a method of forming a packaging web, comprising the steps of:

(a) providing a label web having a surface with a series of alternating adhesive patches and non-adhesive portions;

(b) receiving the label web on a transfer roller;

(c) cutting a label from the label web;

(d) forming an opening in a packaging flow wrap web; and

(e) transferring the label from the transfer roller to the packaging flow wrap web overlying the opening.

Objects, advantages, and features of the present invention will be readily apparent upon a reading of the following detailed description in conjunction with the drawings and the appended claims.

### BRIEF DESCRIPTION OF THE DRAWINGS

FIG. 1 is a perspective view of a package having an opening selectively accessed by a re-sealable overlying island label.

FIG. 2 is a perspective view of a web of a packaging sheet material to which discrete island labels have been affixed during an assembly process according to the present invention.

FIG. 3A is a side elevational view of a web converting machine for applying an island label to a moving web of a packaging sheet material.

FIG. 3B is a side elevation view of a finished product station used with the apparatus illustrated in FIG. 3A.

FIG. 4 is a side elevational view of a deactivator station in an alternate embodiment of the labeled flow wrap apparatus.

### DETAILED DESCRIPTION

Generally, the present application discloses a multi-web converting system for the production of labeled flexible packaging with an improved apparatus and method for making a labeled flow wrap assembly, and particularly for making labeled flow wrap packaging for wipe sheet products and for perishable products. Two separate webs consisting of a) a label material web and b) a “receiving” flow wrap web are converted on the same apparatus with one-pass to make the labeled flow wrap assembly. The label web material is adhesive coated in predetermined patterns or zones and diecut in register into discrete pressure sensitive labels. This eliminates the need for siliconized label liners or carriers in label manufacture and in the assembly process, with attendant benefits of reduced energy costs, materials costs, and disposal handling costs. The flow wrap web is also diecut in register on the same apparatus to form the dispensing opening for the package. The two webs pass through an island placement module where the discrete diecut labels are applied in register to the flow wrap web overlapping the diecut area of the flow wrap. The labeled flow wrap assembly produced thereby is wound into a continuous roll at predetermined lengths. A number of benefits arise from the new apparatus and method, including a) raw material cost savings afforded by the linerless label material compared to the costs of linered label stock, b) manufacturing efficiencies and savings from combining the two converting processes (label and film) on one apparatus and in one pass, c) cost savings from reduced waste disposal for the liner and label matrix, and d) elimination of liner waste, resulting in reduced landfill waste and its inherent negative environmental impact.

The process provides a continuous, one-pass multi-web converting process for producing labeled flow wrap comprising die-cutting of a linerless adhesive-coated web to produce a label, die-cutting of a “receiving” packaging web to produce an opening for the package, retaining as appropriate the cut film in place with ties of perforations, overlapping attachment of the label over the die-cut area of the film, and winding of the labeled film product. The label substrate or material may be printed or unprinted, adhesive coated or uncoated, paper or filmic in nature depending on the end product application. The adhesives for the label are chosen based on the end product application. Suitable adhesives may be permanent or removable/resealable.

In one aspect of the invention, the web from which the label will be die-cut is supplied to the apparatus without adhesive, liner or backing material. This process and apparatus moves two webs simultaneously and results in the labeled flow wrap web assembly. The packaging web may be printed or unprinted, paper or filmic in nature depending on the end product application. The film web may generally bear sensor or registration marks. The film chosen is based on the end application and may consist of a combination of polyolefin materials. The method of the present invention is useful in various applications, including labeling and die-cutting flow wrap film to make a re-sealable film for packaging of wipe sheet products and perishable products as well as other non-woven packaging for products. The label and packaging web may be converted by mechanical means or by laser for perforating, scoring, sheeting or rotary die-cutting.

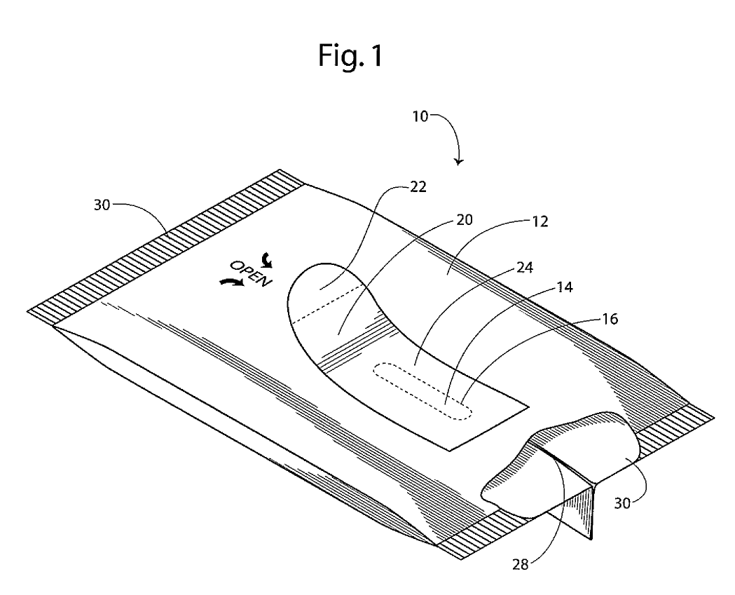

Now with particular reference to the drawings, in which like parts have like identifiers, FIG. 1 illustrates in perspective view a package 10 made with a packaging sheet 12 cut from a packaging web discussed below. The packaging sheet 12 includes a slit generally 14 that defines a separatable cover 16 for an opening through the packaging web into the package 10. Removal or opening of the cover 16 permits the contents of the package 10 to be removed through the opening formed by the slit 14. The contents can be convenience articles including wipe sheets, snacks, and the like. The package 10 includes an island label 20, which in the illustrated embodiment is made of a transparent sheet. The label 20 has a leading portion 22 and a covering portion 24. The label 20 is an “island label” in reference to the adhesively attached label that is otherwise independent of the packaging material to which it is attached. In the illustrated embodiment, the label 20 is substantially centered on the package 10, but it is to be appreciated that the label may readily be applied lateral of a longitudinal axis or a transverse axis of the packaging sheet 12, so the opening can be selectively positioned on the package.

The island label 20 attaches with adhesive to the packaging sheet 12 in overlying relation to the slit 14 and cover 16. In an alternate embodiment, the leading portion 22 lacks adhesive. The leading portion 22 thereby defines a tab readily grasped for pulling the island label 20 from overlying relation relative to the cover 16. The cover 16 attached adhesively to the island label 20 is pulled away from the packaging sheet 12 as the island label is pulled away. This uncovers the opening defined by the slit 14 for removal of the contents from the package 10.

The package 10 is otherwise conventional in its structural assembly for pouches for convenience products. In the illustrated embodiment, the package 10 assembles from the packaging sheet 12. The discrete packaging sheet 12 is cut from a continuous flow web of packaging sheets. Opposing side edges 28 shown in cut-away view are sealingly connected together to form a closed bottom for the pack 10. The overlapped sheet 12 has aligned leading and trailing edges 30 that are sealingly joined together to close the open ends of the package 10.

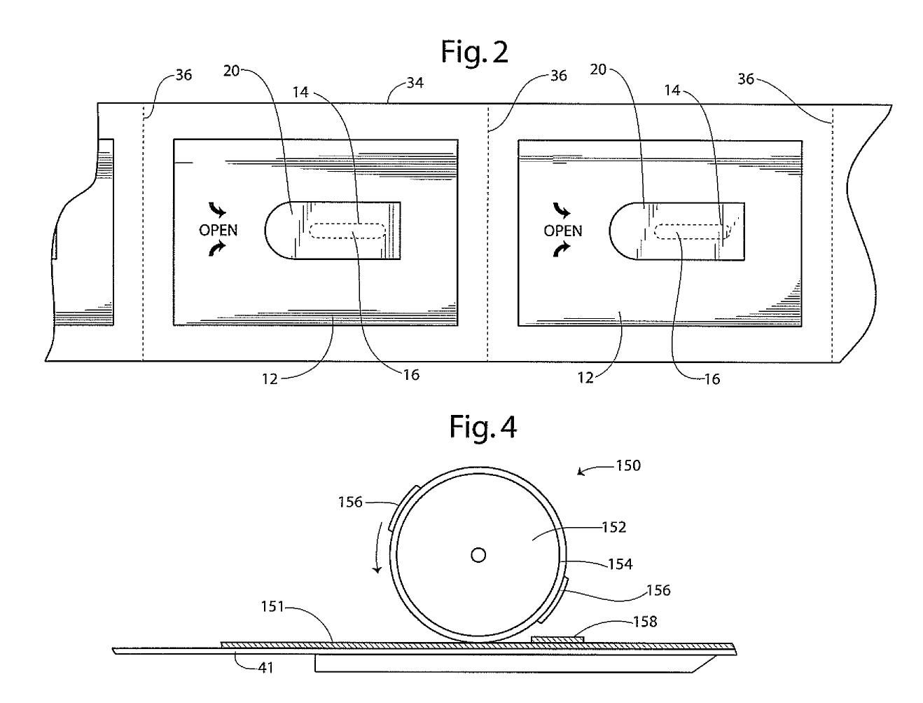

FIG. 2 illustrates in perspective view a web 34 of assembled packaging sheets 12 and applied labels 20. The web 34 includes a spaced sequence of discrete packaging sheets 12 that include appropriate printed graphics and text information for the particular product to be packaged. During a package-filling process by a manufacturer of a product to be enclosed in the package 10, the web 34 is processed with packaging sheets 12 sealed on the opposing side edges 28 to form the bottom and sealed on the overlapping end edges 30 to form the sealed ends and separating from the web into discrete packages. The web 34 includes the applied island label 20 positioned in overlying relation to the opening defined by the slit 14 and the cover 16 for each sheet material 12. The packaging sheets 12 are spaced-apart for separation along cut lines generally 36 intermediate adjacent sheet materials 12.

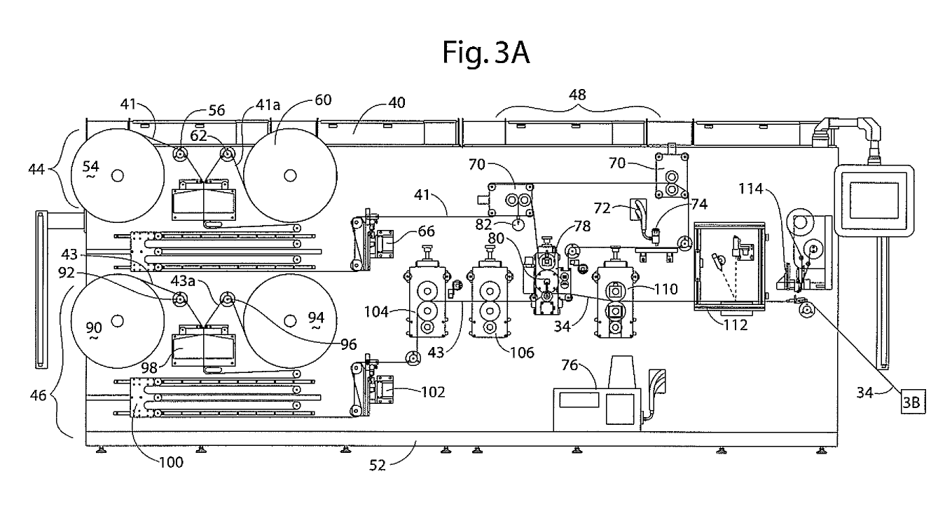

FIG. 3A is a side elevational view of an apparatus or web converting machine 40 for applying island labels 20 from a label substrate or web generally 41 in sequence to packaging sheets 12 of a packaging material substrate or flow wrap web generally 43, to assemble the web 34. The web converting machine 40 includes a finished product station 42 illustrated in FIG. 3B. Generally, the web converting machine 40 includes a label substrate station 44, a packaging substrate station 46, an island preparation and transfer station 48, and the finished product station 42. Each station 44, 46, 48, and 42 include devices appropriate for the function of the station, as discussed below. Generally, the web converting machine 40 moves the unrolled webs of two separate substrates (the label substrate 41 and the package substrate 43) together for applying a label 20 from the label substrate 41 to the receiving package sheet substrate 43 and thereby form the web 34 of assembled labeled packaging sheets that are rolled for use by convenience product manufacturers for packaging.

The web converting machine 40 includes a mainframe generally 52 that supports the component parts in a process sequence. The label substrate station 44 includes a roll mounting unwind station 54 that receives a roll of the label substrate 41 for the label 20. An idler roll station 56 facilitates transport of the label substrate 41 from the roll mounting unwind station 54 to an automatic web splicing station 58. This is a conventional device that facilitates the use of a second roll mounting unwind station 60 having an idler roll station 62 that facilitates transport of a web of the label substrate 41a from the second roll mounting unwind station 60. Use of two roll mounting unwind stations 54 and 60 permits substantially continuous operation of the web converting machine 40. The automatic web splicing station 58 splices the beginning of one roll of label substrate 41 to the end of another roll of the label substrate. A web accumulator 64 assists with the splicing by maintaining tension on the webs of label substrate during splicing. A web guidance frame 66 includes roller guides that automatically move laterally as necessary to keep the web of the label substrate flowing on a correct path. The flow of the web is maintained on a center line for communicating the web into the label preparation and transfer station 48. Powered nip stations 70 provide tension zones for control of the web during the die cut of the label 20 from the substrate 43. The label substrate 41 passes through a hot melt adhesive coating station 72 that includes a hot melt adhesive coating head 74. The coating station 72 applies hot melt adhesive to a surface of the label substrate 41. The coating station 72 communicates with a hot melt adhesive supply 76. The supply 76 includes a heating tank for liquefying a hot melt adhesive, which communicates by a pump to the coating head 74. A rotary die-cutting station 78 includes a knife for cutting the shape of the label 20 in the web of the label substrate 41. An island placement apparatus 80 receives the label 20 cut from the web and places it onto the moving web of the packaging sheet substrate 43. A trim removal station 82 removes trim pieces and waste matrix from the label substrate by vacuum. The waste matrix exits out of the back of the machine 40 or is otherwise disposed of. In an alternate apparatus, the waste matrix may include a trim windup system for forming a roll of the waste matrix.

As set forth above, the island placement apparatus 80 applies the label 20 to the receiving web of a packaging sheet substrate 43 to assemble the web 34. The package label substrate 43 is supplied from a roll mounting unwind station 90. An idler roll station 92 facilitates transport of the packaging substrate 43 from the unwind station 90. The illustrated embodiment includes a second roll mounting unwind station 94 for a second roll of packaging substrate 43a. An idler roll station 96 facilitates transport of the packaging substrate 43 from the roll mounting unwind station 94. An automatic web splicing station 98 facilitates joining of the beginning of one web of the packaging substrate with the end of a second web carried on the separate roll mounting unwind stations 90 and 94. A web accumulator 100 assists with the splicing of the packaging substrate webs by maintaining tension on the webs during splicing, and thus facilitates continuous operation of the web converting machine 40. While one roll mounting unwind station is providing packaging substrate 43 to the web converting machine 40, the other roll mounting unwind station receives a new roll of packaging substrate.

A web guidance device 102 guides the moving flow of the web of the packaging substrate 43 and moves laterally as necessary to keep the web on a center line path through a nip station 104 and into a rotary die station 106. The rotary die station 106 includes a cutting edge, such as a metal blade, knife, or similar cutter, for cutting the slit 14 in the packaging material 12. The nip station 104 operates to fix the packaging substrate web and maintain tension during the cutting step for forming the slit 14. The web 43 with the sequential package sheet material 12 that includes the slit 14 moves to the island placement station 80. The island placement station 80 includes a vacuum roller that communicates with a source of vacuum to hold the label 20 on the roller. The roller rotates to move the label into contact with the package substrate 43. The label transfers from the vacuum roller to the substrate 43 and thereby assembles the web 34.

A nip station 110 receives the web 34 having the label 20 attached to the sheet material 12. The rollers in the nip station firmly press the label 20 into adhesive contact to the packaging substrate 43. An inspection station 112 inspects the web 34 for defects. Upon detection of defects, a marking device 114 marks defective sheet material 12. The machinery that uses the finished roll of the web 34 for forming packages detects the marked defects and eliminates them from use.

With reference to FIG. 3B, web accumulators 120 receive the web 34. The web accumulators 120 maintain tension on the web 34 for handling in the finished product station 42. A web guidance device 122 adjusts laterally to maintain the web on a center line to a turret 124 for winding finished product. The turret 124 in the illustrated embodiment includes three spindles for the finished roll product rewind stations. Idler rollers generally 128 guide the web 34 onto the finished product rewind station 130. When the particular roll is full, the turret rotates to position the finished roll at an unload station 132. The previous spindle is thereby rotated to a start station for receiving the web 34 for winding into a roll. The finished product turret rewind system is conventional, and provides automatic switching based on linear count or numerical count of the web of packaging material 34. The turret 124 rotates to move a new empty core into position while the web 34 is cut from the filled core, and the cut end attaches to the new core. The finished roll is removed from the spindle at the finished roll unloading station 132.

With reference to FIGS. 3A and 3B, the web converting machine 40 receives a label substrate 41, prepares an adhesive backed label 20, separates the label 20 from the substrate 41, transfers the adhesive coated label 40 to the packaging substrate 43, and after inspection, rolls the web 34 of the packaging material sheets 12 assembled with the applied labels 20. More particularly described, the web accumulator 64 maintains tension on the label substrate 41 coming from the roll mounting unwind stations 54 or 60 past the idler rollers 56, 62 respectively and through the automatic web splicing station 58. The web guide device 66 maintains the web on a center line as it moves through the powered nip station 70 and into the hot melt adhesive coating station 72. The coating head 74 communicates with the hot melt adhesive supply 76 and hot melt adhesive is applied to a surface of the label substrate 41. The coating head 74 is suitable for the width of the label 20. For example, a substrate having a width of four inches may yield a three inch wide label 20, and the coating head is commensurate in length with the width of the label. As may be appreciated, chillers or coolers may be used in conjunction with the hot melt adhesive head 74 to reduce the temperature quickly from a melt temperature to a cooled solidified tacky state on the surface of the label substrate 41. Other adhesives, such as screen printable, water-base, or other suitable adhesive can be used, although these require more complex application and curing structures.

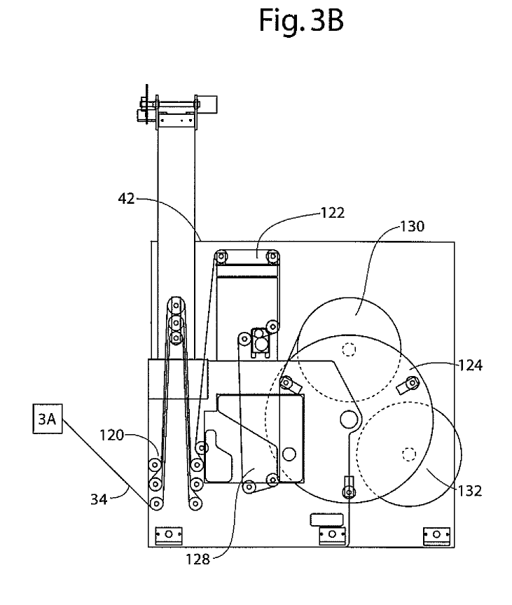

In an alternate embodiment illustrated in FIG. 4, the label substrate 41 is pre-coated with an adhesive surface 151, and selected portions of the adhesive surface are deactivated in-line during the process flow. A deactivator station 150 includes a print roller 152 that communicates with a supply of a deactivator. A plate 154 on the roller 152 defines at least one receiving zone for holding and dispensing the deactivator, with an adjacent non-receiving zone that does not retain the deactivator. The roller 152 brings the plate 154 into contact with the adhesive surface 151 of the label substrate 41. The receiving zone applies the deactivator to selected portions 158 of the label substrate 41. The overcoated portion 158 is cured in a downstream cure station to become deactivated.

The label substrate 41 then moves to the rotary die-cutting station 78. The rotary die 78 includes a vacuum for securing the substrate 41 to the surface of the roller. A cutting surface on a rotary die comes into contact with the label substrate 41 and cuts the shape of the label 20. Generally, the leading edge of the label 20 is oval shaped while an opposing edge is substantially linear. The vacuum on the roller holds the label portion of the substrate 41. A second vacuum pulls the waste matrix of the substrate through an exit in the vacuum trim matrix removal station 82.

The adhesive coated label 20 now held to the roller by vacuum is moved by the rotating roller into contact with the packaging substrate 43 moving from the rotary die station 106.

A brief discussion is in order as to the communication of the packaging substrate 43 to the die station 106. The packaging substrate 43 moves through the web accumulator 100 from the automatic splicing station 98 that is fed by the roll mounting unwind stations 90 and 94. The packaging substrate 43 from these stations pass over respective idler roll stations 92, 96 and into the automatic web splicing station 98 for joining the end of one roll to the beginning of a subsequent roll of the packaging substrate.

The web guidance device 102 aligns the flowing web of the packaging substrate 43 for communication through the nip station 104 and into the rotary die station 106. The rotary die station 106 cuts the slit 14 in the sheet material 12. The slit 14 includes small microperfs at a leading and trailing edge of the opening formed by the slit 114. Typically, the slit 114 defines the cover 16 having a width that is smaller than the overall size of the label. Preferably, the label 20 is about one and half times wider and longer than the width and length of the cover 16 formed by the slit 14. In this way, the island label 20 overlaps extensively on all sides of the cover 16 and the land area of the packaging material around the cover 16.

The web 34 having the sheet material 12 and the applied label 20 passes through the nip station 110. Contact rollers firmly press the adhesive label 20 into contact with the sheet material 12 overlapping the cover 16. The inspection station 112 includes sensors such as a camera for observing the quality of the applied label and sheet material 12. Defective assemblies are marked by the marking device 114 for subsequent detection and are discarded by processing equipment that uses the roll of finished webs 34 for packaging products. The web 34 passes through the web accumulators 120 in the turret rewind station 42. The steering guide 122 maintains the web 34 on a center line for winding on a core on one of the spindles in the turret 124.

With continued reference to FIG. 3A, the web converting machine 40 includes safety control systems, including a light curtain generally 150. The light curtain 150 conventionally stops operating processes on the apparatus 40 if the beam of light is broken, such as by a person or article moving across the light beam and becoming too close to the operating apparatus 40. A operator human machine interface system 152 includes a touch screen panel for display of the operational status of the web converting machine and its various processing stations and devices, including the hot melt adhesive coating supply, vacuum provided to various vacuum rollers, and the like. The interface 152 communicates with a microprocessor controller for system and apparatus operation.

In an alternate embodiment, a laser cutting system is provided rather than the rotary die-cutting stations 106 or 78 for the primary packaging substrate 43 or the label substrate 41.

As may be appreciated, the converting of the primary packaging substrate by rotary or laser cutting of the packaging substrate 43 occurs before attachment of the label 20. In an alternate embodiment however, the island placement could occur prior to the die cut of the packaging substrate 43 to form the cover 30. In such embodiment, the label 20 is die cut and applied to the packaging substrate 43. The die cut station 106 is then positioned down stream of the nip rollers 110. In this embodiment, the die or knife cuts through the packaging substrate 43 to the label material. This embodiment is useful for those materials in which the slit 14 tears, rather than severs, at the microperfs. Thus, in such packaging material, the cover 16 must be completely severed rather than the cover 16 remaining at least partially attached with the microperfs.

It is to be appreciated that an alternate embodiment of the web converting machine 40 uses multiple island preparation and placement stations 48. Each station applies a label 20 to a particular one of the sheet materials 12 on the web in a group of packaging sheets 12, corresponding to the number of label preparation and transfer stations 48 included in the web converting machine 40.

The present invention contemplates using pre-printed label substrate 41, although a printing station such as a flexigraphic station, can be provided to print on the label substrate during processing. Further, the label substrate may be a self-wound adhesive-coated product such as a polypropylene material having a top layer with a release coating. Such embodiment avoids the hot melt adhesive system.

In another embodiment, the label substrate is two-part including an adhesive-coated label web and a backing sheet. The backing sheet is removed from the web converting machine by the backing trim/matrix removal system 82.

The finished product exiting from the marking station 114 may readily be fed, as an alternate, to a sheeting station. Cutters such as guillotine blades, or the like, separate the web 34 into sheets of the sheet material 12 with the attached label 20. Sheet form packaging 12 enables hand application or processing by packaging machinery that uses sheets rather than rolls.

The web converting machine 40 and the process of applying island labels to package sheet material provides environmental benefits through the use of hot melt adhesive in contrast to solvent-based adhesives. The present invention accordingly eliminates the need for siliconized liners that are not readily recyclable and must be thrown away. The process eliminates the waste liner. The process further reduces energy usage particularly in the label stock manufacturing process. Solvent-based compounds require evaporation of VOC compounds. It takes significant energy to drive off the VOC compounds, which is eliminated through the use of the hot melt adhesive. An adhesive with a rapid setting or curing characteristic enables the apparatus 40 to achieve high production rates.

The labeled packaging web assembly 34 provides a readily re-sealable flexible package suitable for wiping sheet products bearing a communicatable material for application, including wet wipe pads or sheets, dry wipes, or other non-woven sheets including those for fabric softeners, surface cleaning wipes, and the like. It is to be further appreciated that the packaging web 34 resulting from the web converting machine 40 and the process disclosed herein provide suitable flexible packaging for cookies, candy, and other perishable foods, as well as packaging for meets, cheeses, coffees, teas, and other food products.

The labeled flow wrap assembly comprises the linerless label web on which an adhesive surface pattern is formed to provide adhesive-free zones and adhesive zones that facilitate the handling of the peelable tab portion of the label by consumers without touching the adhesive. The label material is substantially transparent, and can include printing of text and graphics on a surface, so that the printing is observable through the label. It is within embodiments of the invention to provide printing of graphic and images on the label material during the process, such as printing in one or two colors via flexographic printing technologies. To achieve more than three color printing, or to employ other printing technologies such as gravure and offset printing, would reduce production speeds. Users desiring multiple printing technologies and complex graphics on the label material may achieve that in a separate process on printing presses using non-adhesive label material. Rolls of the resulting printed label material may then be processed on the converting apparatus to form the assembled packaging material.

The use of liner-less label stock provides raw material cost savings over linered label stock. The liner, a highly engineered material, and indeed is not a part of the final assembly, is waste. However, the liner can comprise 30% to 50% of the cost of the label stock. Further, one apparatus, single pass process provides operating cost savings and manufacturing efficiencies over two distinct machines and processes. Also, the linerless process eliminates waste disposal of liners that in most instances are not recyclable.

The method and apparatus provides for single pass manufacturing of a labeled web assembly, with the linerless labels die cut and applied to a moving flow wrap web, and obviating the work-in-process inventories of finished labels needed for the labeled film assembly. The apparatus converts multiple webs with adhesive coating, die cutting, stripping of the waste matrix, label application, and winding of finished product in a single continuous operation. The selective formation of adhesive zones on the label substrate provides a pull tab for the packaged product using the labeled flow wrap assembly. The process permits rapid and inexpensive manufacture of labels in which the printed text and graphics of the label may be buried between the adhesive and a transparent film through which the graphics can be read.

The labeled flow wrap assembly provides end use resealable flexible packaging utilizing a resealable label including but not limited to converted label and film webs as flow wrap assemblies for wet wipes products, dry wipes, laundry dyer sheets, and other similar sheet wipe products, as well as packaging for perishables such as cookies, chips, candy, and other articles.

This specification has described the present invention that provides a multi-web single pass apparatus and method for assembly of a multi-web labeled flow wrap assembly for packaging multiple single-use items such as convenience products. It is to be understood, however, that numerous changes and variations may be made in the construction of the present apparatus and method within the spirit and scope of the present invention, and that modifications and changes may be made therein without departing from the scope thereof as set forth in the appended claims.

What is claimed is:

1. A labeled flow wrap web assembly apparatus, comprising:
a source of a label web having a surface with a series of alternating adhesive patches and non-adhesive portions;
a cutter that receives the label web and cuts a label therefrom, the label having at least an adhesive surface;
a supply of a flow wrap web for forming packaging;
a second cutter that receives the flow wrap web and cuts a slit in the flow wrap web to define an opening for the packaging;
a transfer body that carries the label cut from the label web and transfers the label to the flow wrap web in overlying relation to the opening in the flow wrap web.

2. The apparatus as recited in claim 1, wherein the source of the label web comprises:
a supply of a label web; and
an adhesive station that applies an adhesive selectively to a surface of the label web to define the alternating adhesive patches and non-adhesive portions on the label web.

3. The apparatus as recited in claim 2, wherein the adhesive provides a tacky surface.

4. The apparatus as recited in claim 2, wherein the adhesive is a hot melt adhesive.

5. The apparatus as recited in claim 1, further comprising a station intermediate the adhesive station and the first cutter for curing the adhesive to have a releasably tacky surface.

6. The apparatus as recited in claim 5, wherein the station comprises an air blower blowing air from a supply.

7. The apparatus as recited in claim 5, wherein the station comprises a chill roller.

8. The apparatus as recited in claim 7, wherein the adhesive is a hot melt adhesive.

9. The apparatus as recited in claim 1, wherein the opening defines a tongue attached by a pair of hanging points to the flow wrap web.

10. The apparatus as recited in claim 9, wherein the opening is defined by a clean cut slit in the flow wrap web except for the pair of hanging points.

11. The apparatus as recited in claim 1, further comprising a bump roller that operates to attach the island label to the packaging web overlying the opening.

12. The apparatus as recited in claim 1, wherein the transfer body comprises a vacuum roller that rotates and receives the label web at a first position, contacts the cutter in a second position, and positions the cut label against the flow wrap web at a third position.

13. A method of forming a labeled flow wrap web for packaging, comprising the steps of:
(a) providing a label web having a surface with a series of alternating adhesive patches and non-adhesive portions;
(b) receiving the label web on a transfer roller;
(c) cutting a label from the label web;
(d) forming an opening in a packaging flow wrap web; and
(e) transferring the label from the transfer roller to the packaging flow wrap web overlying the opening.

14. The method as recited in claim 13, wherein the step (a) providing comprises the steps of:
providing a supply of a label web; and
applying an adhesive selectively to a surface of the label web to define the alternating adhesive patches and non-adhesive portions on the label web.

15. The method as recited in claim 14, further comprising the step of curing the adhesive on the surface of the label web.

16. The method as recited in claim 15, wherein the step of cooling comprises blowing air onto the surface of the label web.

17. The method as recited in claim 16, further comprising the step of cooling the air to be blown onto the surface of the label web.

18. The method as recited in claim 13, wherein the step (a) providing comprises the steps of:
providing a supply of a label web having an adhesive surface; and
deactivating the adhesive selectively to define the alternating adhesive patches and non-adhesive portions on the label web.

19. A multi-web converting system for the production of labeled flexible packaging for making labeled flow wrap packaging for wipes and perishable products, comprising two separate webs consisting of a) a label material web and b) a receiving flow wrap web for converting on a apparatus to form a labeled flow wrap assembly, defining predetermined zones of adhesive coating on the label material web, diecutting the label material web in register into discrete pressure sensitive labels in sequence, diecutting a dispensing opening in the receiving flow wrap web for a package in sequence, passing the diecut label material web and the diecut flow wrap web through an island placement module where the discrete diecut labels are applied in register to the flow wrap web with each label in adhesive contact overlapping one of the diecut opening of the flow wrap in sequence to form the labeled flow wrap assembly, and accumulating the labeled flow wrap assemblies for use in making labeled flexible packaging.

20. The multi-web converting system as recited in claim 19, wherein the defining predetermined zones of adhesive coating comprises communicating a hot melt adhesive from a supply to a adhesive head; communicating hot melt adhesive to the label material web, and curing the hot melt adhesive.
